(19) United States
(12) Patent Application Publication
(10) Pub. No.: US 2021/0298469 A1
(43) Pub. Date: Sep. 30, 2021

(54) Cushioning Platform for Print Media and Electronic Devices

(71) Applicant: Michael John Disher, Palm Bay, FL (US)

(72) Inventor: Michael John Disher, Palm Bay, FL (US)

(21) Appl. No.: 16/829,169

(22) Filed: Mar. 25, 2020

(51) Int. Cl. A47B 23/06; F16M 13/02

(52) U.S. Cl. CPC A47B 23/06; F16M 13/04; F16M 13/025

(57) ABSTRACT

A flexible pad for tablet computer, including a flexible bag, the flexible bag includes a storage part with a plurality of fixing belts and a support part, the storage part is opposite to the support part; Inner bag. The flexible pad has an oblong cross-section and a longitudinal cross-section. Its novel shape is convenient for the placement of small electronic devices such as tablet computers and smart phones. It is easy to use, light in weight, and easy to carry. The supporting part is provided with several anti-skid protrusions, which can conveniently place the iPad on the user's thigh or knee.

### TECHNICAL FIELD

The utility model relates to accessories for electronic equipment, in particular a tablet computer flexible pad.

### BACKGROUND TECHNIQUE

With the development and progress of society, a large number of electronic devices are more and more used by people, such as tablet computers and smart phones, and these electronic devices are generally smooth in overall design in order to be beautiful, especially the back cover is smooth and without a stand, you need to use it with your hand. Especially when watching videos, you need to place the electronic device at a certain angle. If you hold it all the time, you will be tired.

In order to meet people's needs, some brackets for these electronic devices are used, for example, the Chinese utility model patent CN201110032168.7 provides a tablet computer bracket. The bracket offers a left and right rotation bracket and an up and down rotation bracket supported by a metal shaft. The up-down, left-right rotation of the tablet computer is realized to meet people's needs for viewing the tablet computer, but the bracket is realized by mechanical design through multiple parts which has the problems of complicated manufacturing, long working hours and inconvenient carrying.

### SUMMARY OF THE INVENTION

In order to solve the above-mentioned technical problems in the existing electronic device bracket, the present invention provides a tablet computer flexible pad, the flexible pad can be used for tablet computers, smart phones and other small electronic devices.

The flexible pad of the tablet computer of the present invention includes a flexible bag, which includes a storage portion and a support portion with a plurality of fixing belts; the inner cavity of the flexible bag is provided with solid particles or an inner bag filled with liquid. The flexible pad has an oblong cross-section and a longitudinal cross-section.

Wherein, the object storage portion is rectangular, and at least two corners of the object storage portion are provided with fixing bands.

The fixing belt has an approximately triangular shape, and both sides thereof are connected to the edge of the placement portion and open toward one side of the central portion of the object storage portion.

The support portion is also provided with a number of protrusions for anti-skid.

The particulate solids disposed in the inner cavity of the flexible bag include foam plastic particles and plastic particles, such as PVC (polyvinyl chloride) particles, ABS plastic particles, and the like. The weight ratio of the foamed plastic particles to the plastic particles is selected between 0.2-1:1. As the particulate solid matter, only PVC particles or the like may be used.

The inner bag for filling liquid (such as water, etc.) is a rubber bag, a plastic bag, or the like. The shape of the rubber bag or the plastic bag approximately matches the shape of the inner cavity of the flexible bag.

A flexible pouch can also be sewn on the storage portion of the flexible pouch. The flexible pouch is open at the top and can be equipped with accessories such as headphones, batteries, data cables, and chargers.

The tablet flexible pad of the utility model has a novel shape and can be conveniently used for placing small electronic devices such as tablet computers, smart phones, etc., and is convenient to use, light in weight, and convenient to carry.

The flexible bag is made of fabric, and the use of different colors of fabric can achieve color coordination with small electronic equipment, avoiding the use of traditional rigid metal parts and plastic parts. The manufacturing process is simple, high efficiency, and low cost.

The support portion of the flexible bag is also provided with a number of protrusions for anti-skid, the tablet flexible pad can be placed on the thigh or knee of the user without slipping off, providing the convenience of using an iPad or the like in the car.

### BRIEF DESCRIPTION

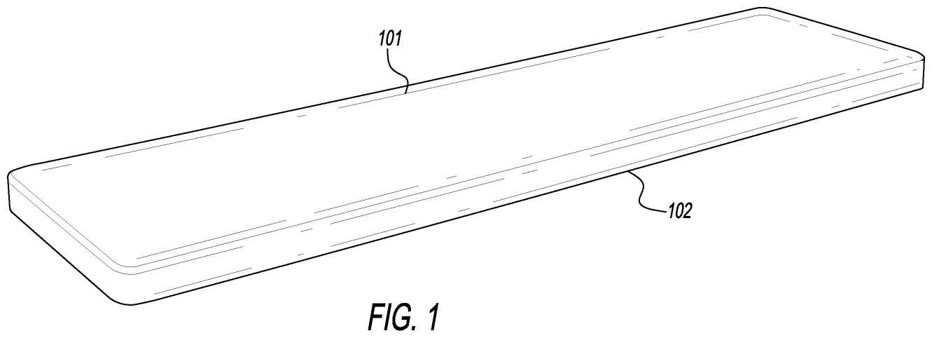

FIG. 1 is a schematic perspective view of a typical embodiment of a flexible pad of the tablet computer;

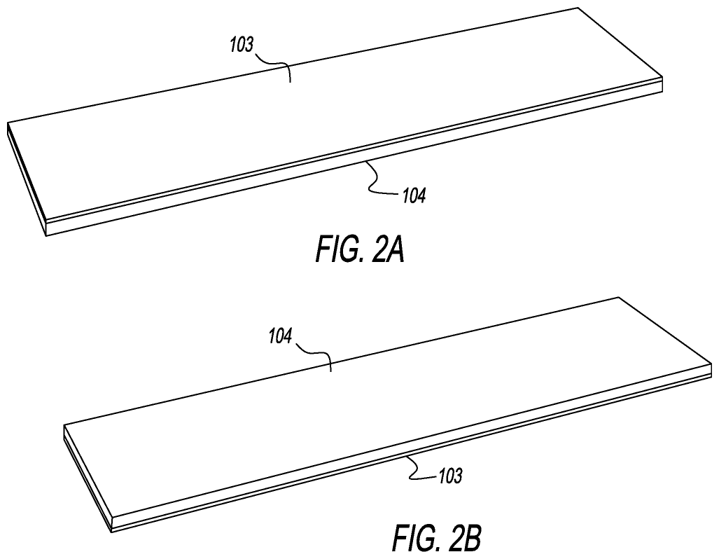

FIG. 2 is another schematic perspective view of the embodiment of FIG. 1;

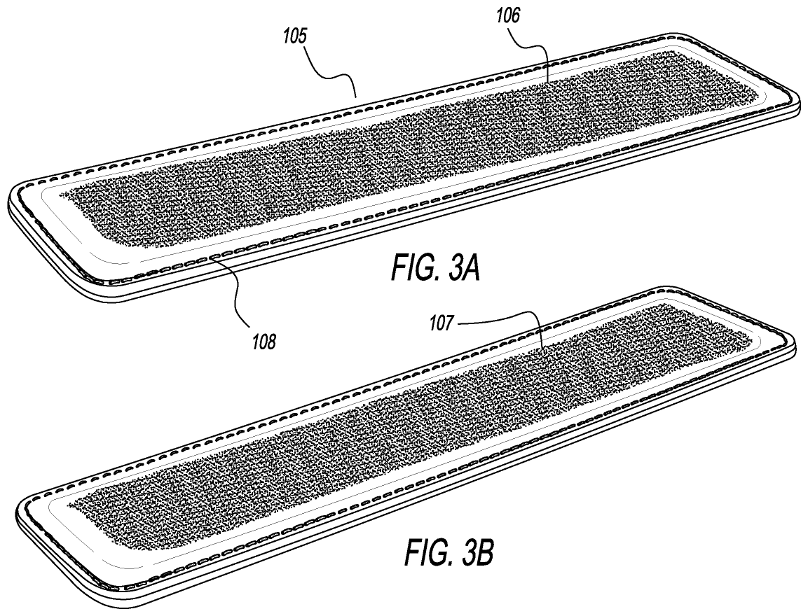

FIG. 3 is a schematic longitudinal cross-sectional view of the embodiment of FIG.

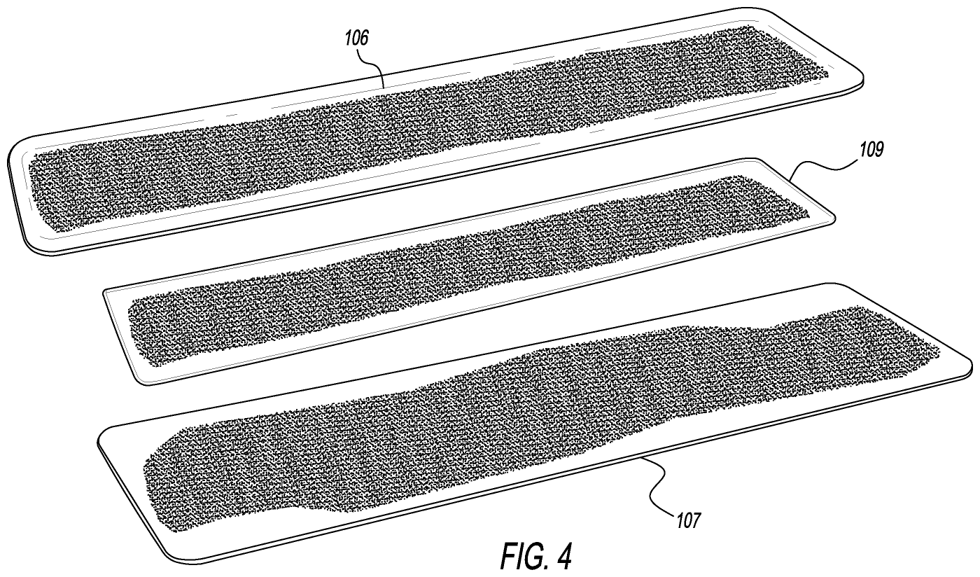

FIG. 4 is a schematic diagram of a state in which an iPad is combined with the embodiment of FIG. 1;

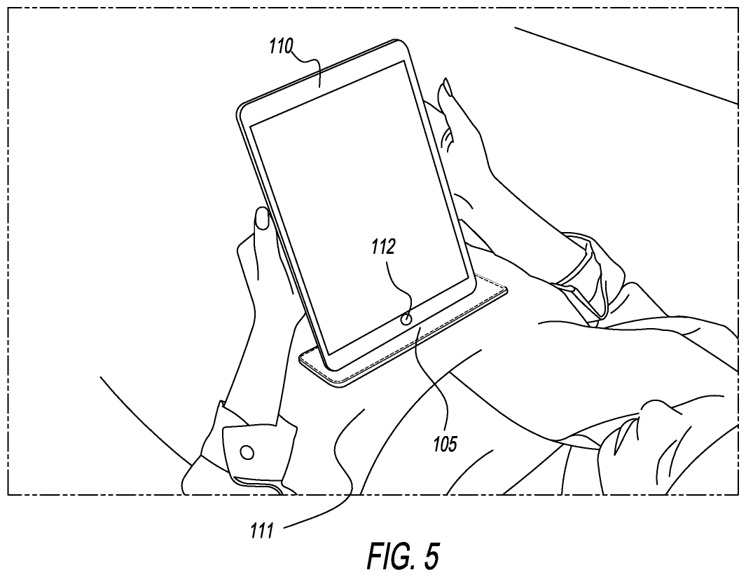

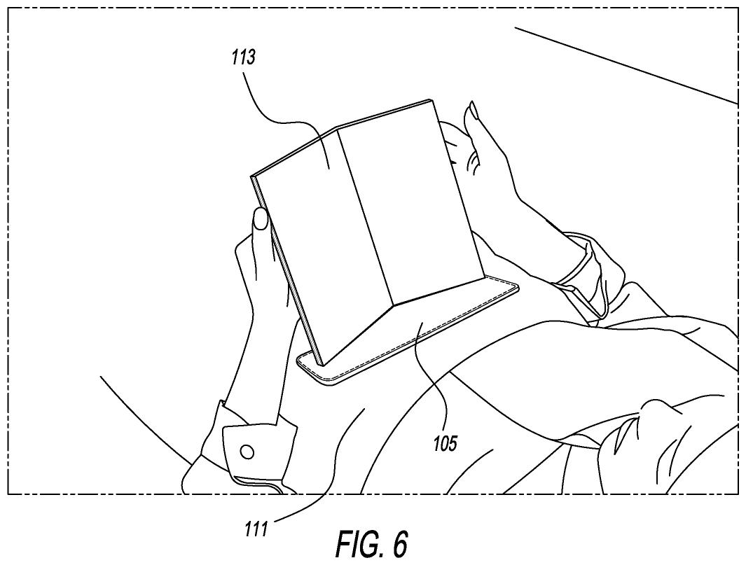

FIG. 5 is an exploded view of FIG. 4.

### DETAILED DESCRIPTION

The utility model will be further described below in conjunction with the embodiments and drawings.

Referring to FIGS. 1-3, the embodiment of the tablet flexible pad includes a flexible bag 1, the flexible bag 1 includes a storage portion 11 with a plurality of fixing belts 111 and a support portion 12; the flexible bag 1 is provided with particles in the inner cavity Solid State 13.

The object placing portion 11 has an approximately rectangular planar shape, and a fixing belt 111 is provided at each corner of the object placing portion 11. The fixing belt 111 has an approximately triangular shape, and two adjacent sides of the fixing belt 111 are connected to the storage portion 11 and open toward one side of the center portion of the storage portion 11. The support portion 12 also has an approximately rectangular shape and is opposed to and substantially parallel to the storage portion 11. In order to prevent the flexible pad from sliding when placed, a plurality of protrusions 121 are provided on the bottom of the support portion 12. The protrusions 121 may be melted plastic particles sprayed on the support portion 12 and cooled.

In order to maintain the shape of the flexible pad, the solid particles 13 need to be filled in the flexible bag 1. In this embodiment, the solid particles 13 are directly filled in the flexible bag 1. The solid particles 13 include foamed plastic particles and PVC particles, and the mass ratio is 1:1. Other ratios can be selected according to the capacity and weight of the flexible bag 1.

The material of the flexible bag 2 may be various fabrics, plastic films, etc. If the fabric is selected as the material of the flexible bag, the production of the flexible bag can be achieved by sewing, if the material of the flexible bag is selected, the adhesive or ultrasonic welding can be used to make flexible bags.

When the flexible bag 1 is made of cloth, first, a triangular fixing belt 111 is sewn to the four corners of the storage part 11, and the peripheral part between the support part 12 and the storage part 11 can be made of a piece of cloth with the support part 12. Fold and sew in the four corners and turn up the edge to form the peripheral part. Put the granular solid 13 between the storage part 11 and the support part 12, and then sew the peripheral parts of the storage part 11 and the support part 12 together to form a flexible bag 1. The granular solid 13 is pulled out of the shape of the flexible bag 1 to form the present flexible pad. The flexible pad has an oblong cross-section and a longitudinal cross-section.

An inner bag filled with liquid may also be provided in the flexible bag 1 to maintain the shape of the flexible pad. The inner bag filled with liquid uses a rubber bag, a plastic bag, or the like. The shape of the rubber bag or the plastic bag is approximately the same as the shape of the inner cavity of the flexible bag 1. The inner bag leaves a certain space so that the liquid can flow within a certain range. The liquid can use water or a solution, mixed liquid, and the like.

In other embodiments, the fixing belt 111 on the object portion 11 may have other shapes and their approximate shapes, such as trapezoids, rectangles and their approximate shapes, etc., as long as they can play a fixing role. The fixing belt 111 is preferably provided at each corner of the object portion 11, or may be provided only at each corner, or may be provided at three corners of the four corners of the object portion 11. The fixing belt 111 can also be set in a manner that can be opened by itself or can be repeatedly detached from the storage portion 11 to facilitate the placement of the electronic device.

The object portion 11 may have a flat shape, a wavy shape, or a collection of other highest points in a flat shape, and the support portion 12 may have a flat shape, a wavy shape, or other collection of lowest points in a flat shape.

A flexible pouch can also be sewn on the storage portion 11 of the flexible bag 1, the flexible pouch is opened at the top, and accessories such as earphones, batteries, data cables, chargers, etc. can be inserted.

Referring to FIGS. 4 and 5, it is a schematic diagram of the flexible pad when it is applied, wherein the flexible pad is the same as the embodiment shown in FIG. 1, the electronic device 2 is an iPad, and in use, the four corners of the iPad are housed in fixed Between the belt 111 and the storage part 11, the iPad can be conveniently placed on the knee or other places for operation.

The electronic device may also be a tablet computer, a smart phone, a PAD, etc., such as an iPad, an iPhone, etc. When specifically applied to an electronic device, a flexible pad having a corresponding size placement portion may be made according to its size.

The above-mentioned embodiments and detailed description are only used to explain the present invention and should not be understood as a limitation to the present invention. All the various transformation designs made according to the scope of the patent applications listed should be included in the protection scope of the claims of the utility model.

1. A flexible pad for a tablet computer, characterized in that it includes a flexible bag, which includes a storage portion and a support portion with a plurality of fixing straps; the inner cavity of the flexible bag is provided with solid particles or filled with liquid Inner bag.
The flexible pad for a tablet computer according to claim 1, wherein the storage part is rectangular, and at least two corners of the four corners of the storage part are provided with the fixing bands.
The flexible pad for a tablet computer according to claim 1 or 2, wherein the fixing belt has an approximately triangular shape, and both sides thereof are connected to the edge of the storage part and open toward one side of the central part of the storage part.

4. The flexible pad for a tablet computer according to claim 1, wherein the solid particles are plastic particles or a mixture of foamed plastic particles and plastic particles.

5. The flexible pad for a tablet computer according to claim 4, wherein the weight ratio of the foamed plastic particles to the plastic particles is 0.2-1:1.

6. The flexible pad for a tablet computer according to claim 1, characterized in that: the peripheral portion between the support portion and the storage portion and the support portion are made of a piece of cloth, and the four corners of the cloth are folded inward and turned upward The edge forms this peripheral portion.

7. The flexible pad for a tablet computer according to claim 1, wherein the inner bag is a rubber bag or a plastic bag.

8. The flexible pad for a tablet computer according to claim 1, wherein the supporting portion is further provided with a number of protrusions for anti-skid.

9. The flexible pad for a tablet computer according to claim 1, wherein a flexible pouch is stitched on the storage portion of the flexible pouch, the flexible pouch is opened at the top. 10.

10. The flexible pad of a tablet computer according to claim 1, wherein the flexible pad of the tablet computer has an oblong cross section and a longitudinal section.
